(19) United States
(12) Patent Application Publication
(10) Pub. No.: US 2017/0071137 A1
(43) Pub. Date: Mar. 16, 2017

(54) Planter Box

(71) Applicant: Brian Mehler, Long Beach, CA (US)

(72) Inventor: Brian Mehler, Long Beach, CA (US)

(21) Appl. No.: 14/756,515

(22) Filed: Sep. 14, 2015

(51) Int. Cl. A01G 9/02

(52) U.S. Cl. CPC A01G 9/026; A01G 9/022

(57) ABSTRACT

The present invention is a planter box, in particular, a pre-fabricated planter box for vertical gardening. The preferred embodiment of the planter box comprises a tower sheet and a base sheet. The tower sheet has a plurality of score lines and pre-cut pockets. The tower sheet has an end panel and an opposite end. The tower sheet is folded along the plurality of score lines to form a tower by attaching the end panel to the opposite end of the tower sheet. The base sheet has a plurality of base score lines where the base sheet is folded along the plurality of base score lines to form a base. The base is inserted into the tower and attached by nylon post screws. The base sheet and tower sheet are preferably made of high impact polypropylene copolymer with a UV-resistant additive. The tower has tapered walls for stability.

### TECHNICAL FIELD

The present invention is a planter box, in particular, a pre-fabricated planter box for vertical gardening.

### BACKGROUND ART

Vertical gardening is a gardening methodology for use when space and/or water are at a premium. Generally, plants are grown in various vertical structures to reduce the amount of land and water needed to cultivate the plants. However, these vertical structures are often complicated, expensive or difficult to construct. What is needed is a low-cost, easy to construct planter box for use in vertical gardening.

### SUMMARY OF THE INVENTION

The present invention is a planter box, in particular, a pre-fabricated planter box for vertical gardening. The preferred embodiment of the planter box comprises a tower sheet and a base sheet. The tower sheet has a plurality of score lines and pre-cut pockets. The tower sheet has an end panel and an opposite end. The tower sheet is folded along the plurality of score lines to form a tower by attaching the end panel to the opposite end of the tower sheet. The base sheet has a plurality of base score lines where the base sheet is folded along the plurality of base score lines to form a base. The base is inserted into the tower and attached by nylon post screws. The base sheet and tower sheet are preferably made of high impact polypropylene copolymer with a UV-resistant additive. The tower has tapered walls for stability.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a front perspective view of a preferred embodiment of the invention with soil and plants installed;

FIG. 2 is a top view of a preferred embodiment of a pre-assembly sheet for the walls of a preferred embodiment of the invention;

FIG. 3 is a front perspective exploded view of a preferred embodiment of the invention;

FIG. 4 is a top view of a preferred embodiment of a pre-assembly sheet for the base of a preferred embodiment of the invention;

FIG. 5 is a back perspective view of a preferred embodiment of the invention.

### DETAILED DESCRIPTION OF THE PREFERRED EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide an improved planter box.

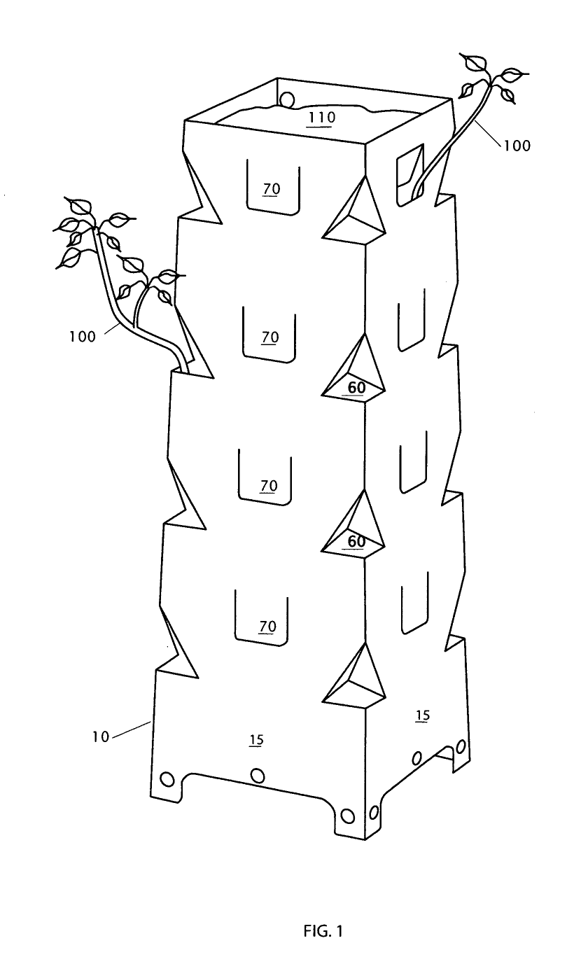

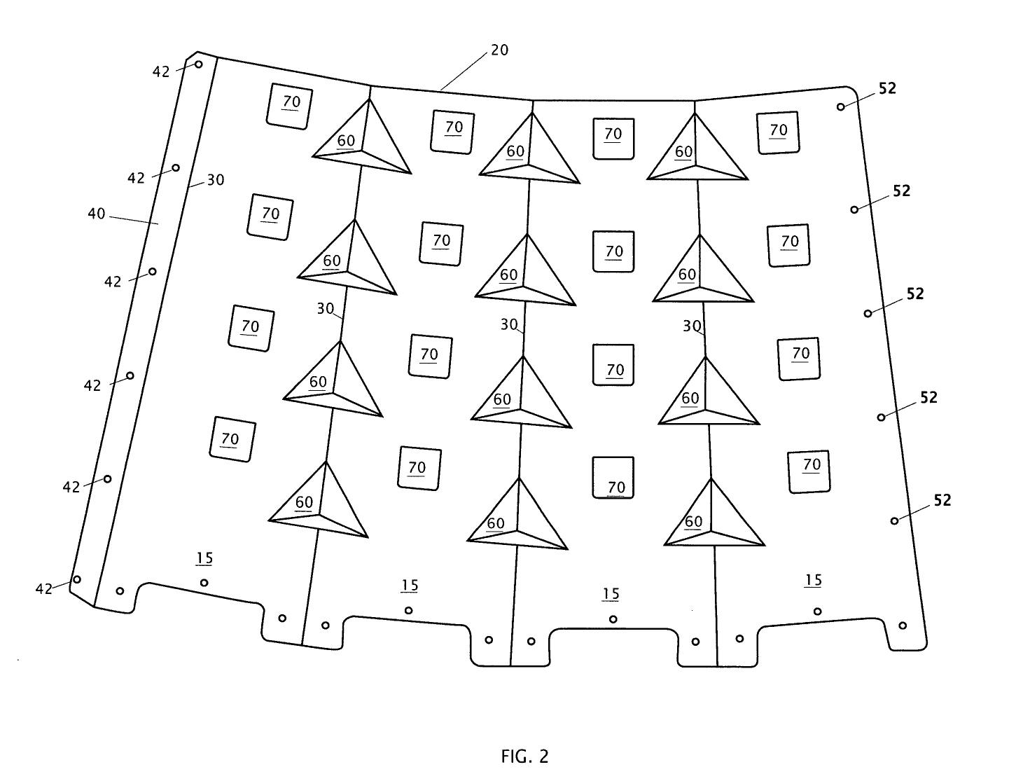

Referring now to FIG. 1, a front perspective view of a preferred embodiment of the invention 10 is shown. Preferably, the planter box 10 is preferably four-sided (though other polygons are possible) with tapered walls 15 such that the top of the invention 10 is narrower than the base. This taper adds stability to the invention. As shown in FIG. 2, the walls 15 of the preferred embodiment are constructed from a single sheet or tower sheet 20, preferably a twin-wall plastic sheet product base on a high impact polypropylene copolymer, such as COROPLAST®. Preferably, the plastic has an additive to resist ultraviolet (UV) light, e.g. from sunlight, to delay or prevent breakdown of the plastic over time due to exposure.

Preferably, the tower sheet 20 is die cut by a steel rule die. The direction of corrugation is preferably from the top to the bottom of the invention 10 to add strength to the walls 15. The sheet 20 shown in FIG. 2 is scored along four lines 30 so that the sheet 20 can preferably be folded into four walls 15. One of the lines 30 preferably defines a side of an end panel 40. The end panel 40 preferably has holes 42 that align with holes 52 on the opposite end of the sheet 20. Accordingly, when the sheet 20 shown in FIG. 2 is folded along the score lines 30, the invention 10 with four walls 15 shown in FIG. 1 is constructed.

The sheet 20 preferably further comprises a number of corner pockets 60 scored into the sheet 20. The corner pockets 60 are preferably located along the score lines 30. When the invention is constructed, the corner pockets 60 can be pushed into the unit to create space for growing a plant 100 as shown in FIG. 1. The sheet 20 further preferably comprises a number of side pockets 70 scored into the sheet 20. The side pockets 70 are then located on the walls 15 of the preferred embodiment. When the invention is constructed, the side pockets 70 can be pushed into the unit to create space for growing a plant 100 as shown in FIG. 1.

When the sheet in FIG. 2 is assembled into the embodiment shown in FIG. 1, the holes 42 of the end panel 40 are aligned with the holes 52 on the opposite end of the sheet 20. Preferably, nylon binding post screws are then inserted through holes 42 and 52 to join the ends of the sheet 20 together. Alternately, aluminum binder posts, Christmas tree clips, snap clips, or aluminum pop rivets could also be used as binders. Also, the end panel 40 can be bonded to the opposite end of the sheet with ultrasonic or heat stake bonding.

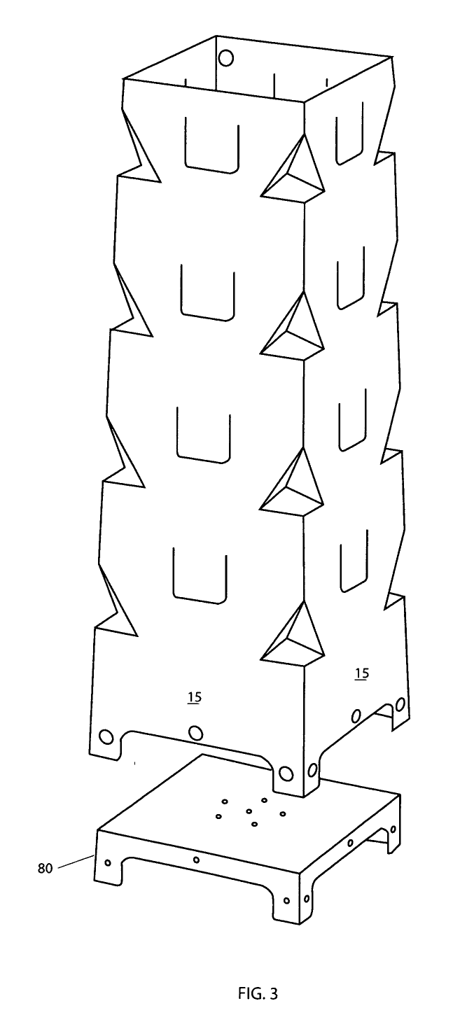

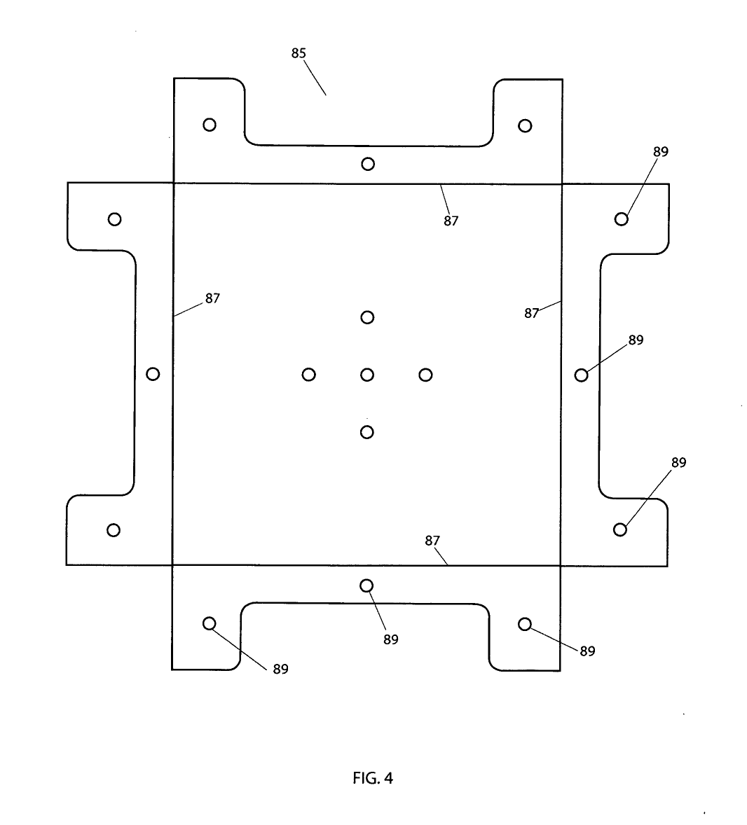

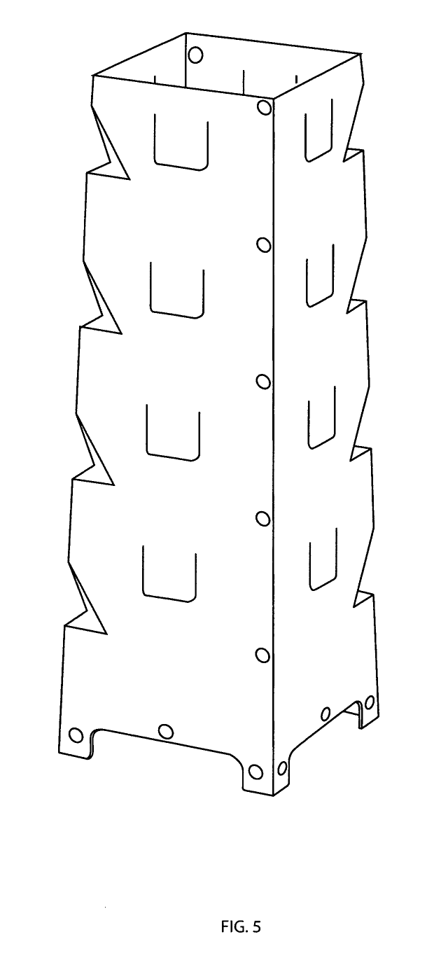

Referring now to FIG. 3, the invention 10 also preferably comprises a base 80 that is inserted between the walls 15. The base 80 is preferably constructed from a base sheet 85 as shown in FIG. 4. The base sheet 85 is also preferably a twin-wall plastic sheet product base on a high impact polypropylene copolymer, such as COROPLAST®. Preferably, the plastic has an additive to resist ultraviolet (UV) light, e.g. from sunlight, to delay or prevent breakdown of the plastic over time due to exposure. The base sheet 85 is also preferably die cut by a steel rule die. By folding along base score lines 87 shown in FIG. 4, the base 80 is four-sided. Furthermore, the base 80 can be attached to the walls 15 of the invention 10 by nylon binding post screws (or other binding apparatus described above) at holes 89. A preferred embodiment of the invention 10 with the nylon binding post screws holding the end panel 40 and base 80 in place is shown in FIG. 5. By attaching the base 80 to the walls 15, bulging due to water and soil pressure is reduced.

Referring back to FIG. 1, once the base 80 is inserted between the walls 15, the invention 10 can be filled with soil 110. Additionally, the soil 110 can be watered and the water allowed to travel the height of the invention 10 to the various side pockets 70 and corner pockets 60 with plants 100. The portions of the sheet 20 pushed in to create the side pockets 70 and corner pockets 60 also preferably act to divert dirt and water away from the space needed for growing a plant 100 (but not away from the roots of the plant 100 where it is needed.)

The preferred tapered shape of the walls 15 and the equal distribution of plants on each side of the invention 10 allows for a reduced amount of water required to hydrate plants growing in the planter box 10. Watering individual pockets 60 and 70 can be done if necessary but is typically not required. The base 80 also helps increase the strength of the bottom of the walls 15 and holds soil 110 inside the box 10.

The preferred tower sheet 20 and base sheet 85 components of the box 10 allow the unassembled planter box to be easily shipped and also use a minimal amount of retail space. Once constructed, the preferred embodiment box 10 shown in FIG. 1 can have 28 individual pockets (plus the top of the box) for planting in less than 1 square foot of space or approximately 0.76 sq. ft. per planter box.

Thus, an improved planter box is described above that is inexpensive and easy to assemble for vertical gardening. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A planter box comprising a tower sheet and a base sheet where:
the tower sheet has a plurality of score lines and pre-cut pockets and the tower sheet is folded along the plurality of score lines to form a tower;
and where the base sheet has a plurality of base score lines where the base sheet is folded along the plurality of base score lines to form a base; and,
where the base is inserted into the tower.

2. The planter box of claim 1 where the tower has tapered sides.

3. The planter box of claim 1 where the tower sheet and base sheet comprise a high impact polypropylene copolymer.

4. The planter box of claim 3 where the high impact polypropylene copolymer further comprises a UV-resistant additive.

5. The planter box of claim 1 where the tower sheet comprises an opposite end and an end panel where the end panel is attached to the opposite end by nylon post screws.

6. A planter box tower sheet comprising high impact polypropylene copolymer and a UV-resistant additive where the tower sheet has a plurality of score lines such that the tower sheet can be folded into a tower with a plurality of side pockets and corner pockets.

7. The planter box tower sheet of claim 6 where the tower sheet further comprises an end panel with a plurality of holes and an opposite end with a plurality of holes aligned with the end panel holes and a plurality of nylon post screws to attach the end panel to the opposite end.

8. The planter box tower sheet of claim 7 where the tower sheet can be folded along the plurality of score lines into a tower with tapered walls.
